(19) United States
(12) Patent Application Publication
(10) Pub. No.: US 2013/0262737 A1
(43) Pub. Date: Oct. 3, 2013

(54) STORAGE CONTROL APPARATUS , STORAGE APPARATUS, INFORMATION PROCESSING SYSTEM AND PROCESSING METHOD

(71) Applicant: SONY CORPORATION, Tokyo (JP)

(72) Inventors: Kenichi Nakanishi, Tokyo (JP); Keiichi Tsutsui, Kanagawa (JP); Yasushi Fujinami, Tokyo (JP); Naohiro Adachi, Tokyo (JP); Ken Ishii, Tokyo (JP); Hideaki Okubo, Saitama (JP); Tatsuo Shinbashi, Tokyo (JP)

(73) Assignee: SONY CORPORATION, Tokyo (JP)

(21) Appl. No.: 13/781,260

(22) Filed: Feb. 28, 2013

(30) Foreign Application Priority Data
Mar. 27, 2012 (JP) 2012-070830

(51) Int. Cl. G06F 12/06

(52) U.S. Cl. CPC G06F 12/0623
USPC 711/5

(57) ABSTRACT

Disclosed herein is a storage control apparatus including: a command processing section configured to receive a command requesting accesses to a plurality of access units by specifying an address in a memory space including a plurality of banks; and an address generating section configured to generate an address of an access unit serving as an object of the accesses in a bank selected from the banks as a bank determined in advance for the specified address.

### BACKGROUND

In general, the present technology relates to a storage control apparatus. More specifically, the present technology relates to a storage control apparatus for a non-volatile memory, a storage apparatus employing the storage control apparatus, an information processing system employing the storage apparatus, a processing method provided for the storage control apparatus and a program to be executed by a computer for implementing the method.

In an information processing system, typically, a DRAM (Dynamic Random Access Memory) is used as a work memory. This DRAM is normally a volatile memory. That is to say, when the power supply of the DRAM is turned off, data stored in the DRAM is inevitably lost. In recent years, however, an NVM (Non-Volatile Memory) is used. The non-volatile memories are classified into two large categories. The first category is a flash memory which allows a storage unit with a large size to be used as an access unit in accesses to data stored in the memory. On the other hand, the second category is an NVRAM (Non-Volatile Random Access Memory) which allows a storage unit with a small size to be used as an access unit in accesses made at a high speed as random accesses to data stored in the memory. A representative of the flash memory is a NAND-type flash memory. On the other hand, typical examples of the non-volatile random access memory are a ReRAM (Resistance RAM), a PCRAM (Phase-Change RAM) and an MRAM (Magneto Resistive RAM).

In the NVRAM allowing a storage unit with a small size to be used as an access unit in accesses made at a high speed as random accesses to data stored in the memory as described above, an address input following a command issued for the memory is an overhead which cannot be ignored. In particular, in the case of a multi-bank access, page addresses are supplied at the same time for a plurality of banks in order to transfer data from the banks to the data requester so that the speed of the access must be improved generally. In such a case, for a page having a size of 32 bytes for example, by making a multi-bank access to 16 banks, 512-byte data can be transferred. If the page address specified for each of the 16 banks has a size of 4 bytes, it is necessary to transfer address information of 64 bytes to the 16 banks. Thus, the address information undesirably has a size greater than 10% of the size of the transferred data. If the page has a size of 512 bytes and data is transferred by carrying out an ordinary burst transfer of data, only start-address information of 4 bytes needs to be supplied in order to transfer the whole data. In such a case, the start-address information is smaller than 1% of the size of the transferred data.

In addition, in accordance with the LPDDR specifications of the DRAM, command and address signals need fan-out so that there are many cases in which the clock rate of the command and address signals is lower than the clock rate of the data signal. In such cases, the overhead further increases undesirably.

When a system making access to the NVRAM described above is taken into consideration, on the other hand, the optimum length of data has a variety of values according to applications carried out in the system, that is, the optimum length varies from application to application. For example, the size of a transfer area used for transferring data from an HDD (Hard Disk Drive) or a flash card is about 512 bytes. In addition, the size of a management area used for storing information for managing the transfer area is 32 or 64 bytes. This size of 32 or 64 bytes is an entry size of a file system such as the FAT. In the case of accesses to a swap area of a virtual memory system, a size of 4 Kbytes is adopted. The size of 4 Kbytes is the size of a virtual page. In order to implement these transfers of data with a high degree of efficiency, a plurality of burst lengths can also be supported. However, the overhead of the burst transfer is undesirably put in an increasing direction due to, among others, the fact that it becomes necessary to also transfer information specifying the burst length as additional information.

In order to solve the above problems, for example, there has been provided a semiconductor storage apparatus having a plurality of sub-capsule arrays and allowing the page size to be selected with a high degree of freedom. For more information on this semiconductor storage apparatus, refer to documents such as Japanese Patent Laid-open No. 2003-331588.

### SUMMARY

In accordance with the existing technology described above, however, it is necessary to specify an address for every page so that the overhead of an access to the memory undesirably increases. In particular, for a small page as is the case with the NVRAM, the difference in size between the command or the address and the page decreases so that the overhead for transmitting the command and/or the address as well as the page relatively increases. Thus, the overhead for carrying out a burst transfer undesirably increases.

It is thus an aim of the present technology addressing the problems described above to shorten the specification of an address in an access to a plurality of access units in a memory space including a plurality of banks.

In order to solve the problems described above, in accordance with a first mode of the present technology, there is provided a storage control apparatus including:

a command processing section configured to receive a command requesting accesses to a plurality of access units by specifying an address in a memory space including a plurality of banks; and

an address generating section configured to generate an address of an access unit serving as an object of the accesses in a bank selected from the banks as a bank determined in advance for the specified address.

In addition, in accordance with the first mode of the present technology, there is provided a storage control method for the storage control apparatus.

Thus, the present technology brings about an effect of making it possible to make an access to a bank selected from the banks in the memory space to serve as a bank determined in advance for the specified address.

In addition, the storage control apparatus according to the first mode of the present technology further has a set-information storing section configured to store set information which includes the number of banks to be accessed at the same time in accordance with an address in the memory space and the number of access units in each of the banks. In this case, the address generating section may generate an address of an access unit serving as an object of the accesses in accordance with the set information.

Thus, the present technology brings about an effect of making it possible to make an access to each bank on the basis of the set information which includes the number of banks to be accessed at the same time in accordance with an address in the memory space and the number of access units in each of the banks.

In addition, according to the first mode of the present technology, the address generating section may generate an address for each of different banks in accordance with a bank count included in the set information to represent the number of banks to be accessed at the same time.

Thus, the present technology brings about an effect of making it possible to make accesses to a plurality of banks at the same time.

In addition, according to the first mode of the present technology, the address generating section may generate successive addresses of consecutive access units in every bank in accordance with an access-unit count included in the set information to represent the number of access units.

Thus, the present technology brings about an effect of making it possible to make an independent access to every bank.

In addition, according to the first mode of the present technology, the address specified in the command is a start address of the accesses made in accordance with the command. In this case, the address generating section may generate an address of an access unit serving as an object of the accesses by making use of the start address as an origin.

Thus, by making use of the start address as an origin, the present technology brings about an effect of making it possible to make an access to a bank selected from a plurality of banks to serve as a bank determined in advance.

In addition, in accordance with a second mode of the present technology, there is provided a storage apparatus including:

a memory array including a plurality of banks;

a command processing section configured to receive a command requesting accesses to a plurality of access units by specifying an address in a memory space of the memory array; and

an address generating section configured to generate an address of an access unit serving as an object of the accesses in a bank selected from the banks as a bank determined in advance for the specified address.

Thus, the present technology brings about an effect of making it possible to make an access to a bank selected from the banks in the memory space of the memory array including the banks to serve as a bank determined in advance for the specified address.

In addition, in accordance with the second mode of the present technology, the memory array may employ memory cells which are each a variable-resistance device.

In addition, in accordance with a third mode of the present technology, there is provided an information processing system including:

a memory array including a plurality of banks;

a command processing section configured to receive a command requesting accesses to a plurality of access units by specifying an address in a memory space of the memory array;

an address generating section configured to generate an address of an access unit serving as an object of the accesses in a bank selected from the banks as a bank determined in advance for the specified address; and

a host computer issuing a read command or a write command to the memory array.

Thus, the embodiments of the present technology brings about an effect of making it possible to make an access to a bank selected from the banks in the memory space of the memory array including the banks to serve as a bank determined in advance for the specified address.

In addition, in accordance with the present technology, in accesses to a plurality of access units in a memory space including a plurality of banks, there is exhibited an excellent effect of making it possible to shorten the specification of an address.

### BRIEF DESCRIPTION OF THE DRAWINGS

FIG. 1 is a block diagram showing a typical configuration of an information processing system according to an embodiment of the present technology;

FIG. 2 is a block diagram showing a typical configuration of a memory system according to an embodiment of the present technology;

FIG. 3 is a block diagram showing a typical configuration of a bank control part according to an embodiment of the present technology;

FIGS. 4A to 4D are diagrams showing typical transmission timings of commands executed to make memory accesses by carrying out burst transfers;

FIGS. 5A and 5B are diagrams showing typical formats of commands for carrying out burst transfers in accordance with an embodiment of the present technology;

FIG. 6 is a diagram showing typical assignment of addresses to pages in a first embodiment of the present technology;

FIG. 7 is a diagram showing typical assignment of area numbers to areas in the first embodiment of the present technology;

FIG. 8 is a diagram showing typical set information for each area in the first embodiment of the present technology;

FIGS. 9A to 9D are diagrams showing access addresses for set information in the first embodiment of the present technology;

FIG. 10 is a flowchart representing a procedure for processing a burst-transfer read command in accordance with an embodiment of the present technology;

FIG. 11 is a flowchart representing a procedure for processing a burst-transfer write command in accordance with an embodiment of the present technology;

FIG. 12 is a diagram showing typical assignment of addresses to pages in a second embodiment of the present technology;

FIG. 13 is a diagram showing typical set information for each area in the second embodiment of the present technology;

FIGS. 14A to 14D are diagrams showing access addresses for set information in the second embodiment of the present technology; and

FIG. 15 is a diagram showing typical usages of areas for a case in which an embodiment of the present technology is applied to an information processing system.

### DETAILED DESCRIPTION OF THE PREFERRED EMBODIMENTS

Embodiments of the present technology are described below. The description is divided into topics arranged as follows.

1: First Embodiment (Consecutive addresses are assigned to pages in each bank)
2: Second Embodiment (Consecutive page addresses are spread over banks)
3: Typical Application (Assumed real application)

### 1: First Embodiment

### Configuration of Information Processing System

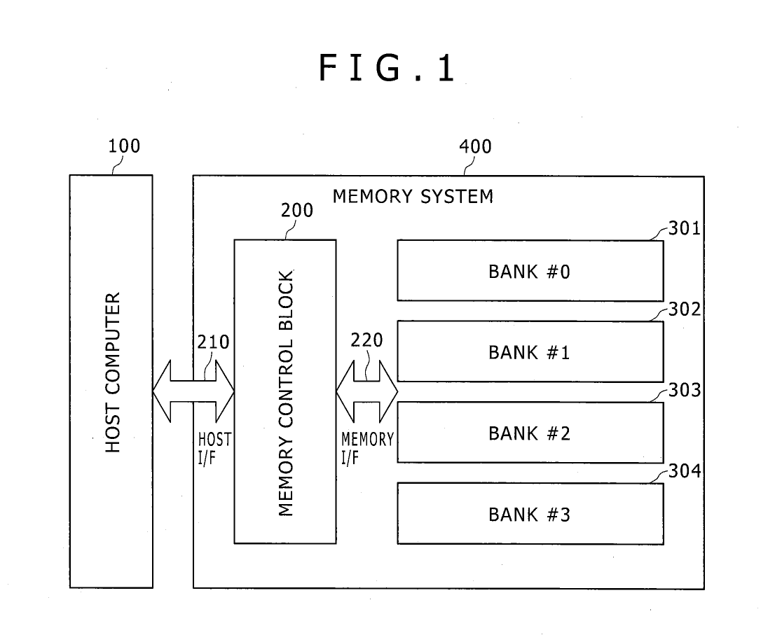

FIG. 1 is a block diagram showing a typical configuration of an information processing system according to an embodiment of the present technology. As shown in the figure, the information processing system includes a host computer 100 and a memory system 400 which includes four banks referred to hereafter as banks 301 to 304 respectively. The number of banks is typical. That is to say, the number of banks can be set at any value according to the specification of the information processing system. In addition, the memory system 400 also has a memory control block 200.

The host computer 100 is a section configured to issue commands for reading or writing data to the memory system 400.

Each of the banks 301 to 304 is a non-volatile memory. To be more specific, each of the banks 301 to 304 is assumed to be an NVRAM (Non-Volatile Random Access Memory) which allows a storage unit with a small size to be used as an access unit in accesses made at a high speed as random accesses to data stored in the memory. Typical examples of the non-volatile random access memory are a variable-resistance ReRAM (Resistance RAM), a PCRAM (Phase-Change RAM) and an MRAM (Magneto Resistive RAM). In this embodiment, it is assumed that the NVRAM is a ReRAM particularly making use of a variable-resistance device.

The memory control block 200 is a configured to control the banks 301 to 304 in accordance with a request made by the host computer 100. The memory control block 200 includes a host interface 210 on the host-computer side and a memory interface 220 which is provided on the bank side for each of the banks 301 to 304. The host interface 210 is an I/F (interface) between the host computer 100 and the memory control block 200 whereas the memory interface 220 is an I/F between the memory control block 200 and the banks 301 to 304.

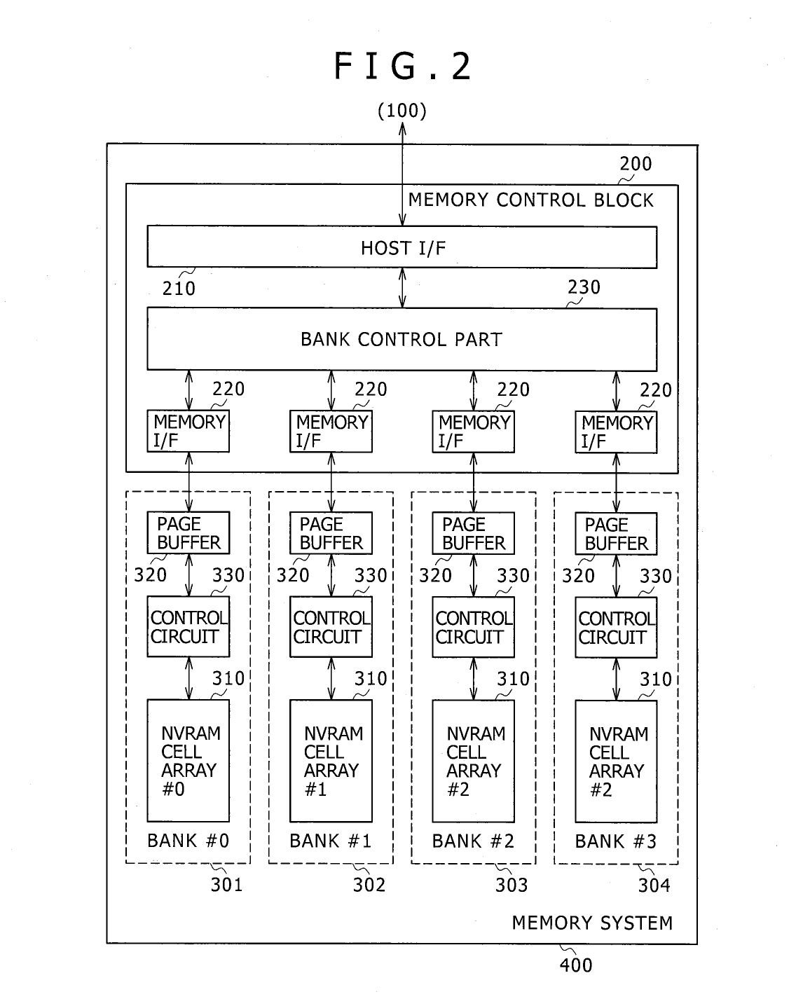

FIG. 2 is a block diagram showing a typical configuration of the memory system 400 according to an embodiment of the present technology. As described above, the memory system 400 includes the memory control block 200 and the banks 301 to 304. The memory control block 200 also has a bank control part 230 in addition to the host interface 210 and the memory interface 220. In addition, each of the banks 301 to 304 includes an NVRAM cell array 310, a page buffer 320 and a control circuit 330.

The host interface 210 is an interface for carrying out interactions between the host computer 100 and the memory control block 200 whereas each of the memory interfaces 220 is an interface for carrying out interactions between the memory control block 200 and one of the banks 301 to 304. The bank control part 230 is a configured to make a multi-bank access by controlling the banks 301 to 304. A detailed configuration of the bank control part 230 will be described later.

The NVRAM cell array 310 is assumed to be an array of NVRAM cells which are each a ReRAM variable-resistance device as described before. The NVRAM cell array 310 is included in each of the banks 301 to 304. The NVRAM cell array 310 included in a specific bank is physically separated from the NVRAM cell array 310 included in any bank other than the specific bank. Addresses can be properly assigned to the banks 301 to 304.

The page buffer 320 is provided for each of the NVRAM cell arrays 310 and used for storing data to be written into a page of the NVRAM cell array 310 or data read out from a page of the NVRAM cell array 310. The page is an access unit exchanged between the page buffer 320 and the NVRAM cell array 310.

In each of the banks 301 to 304, the control circuit 330 is provided between the NVRAM cell array 310 and the page buffer 320 to serve as a circuit for controlling accesses to the NVRAM cell array 310.

It is to be noted that the NVRAM cell array 310 is a typical memory array cited in a claim of this specification.

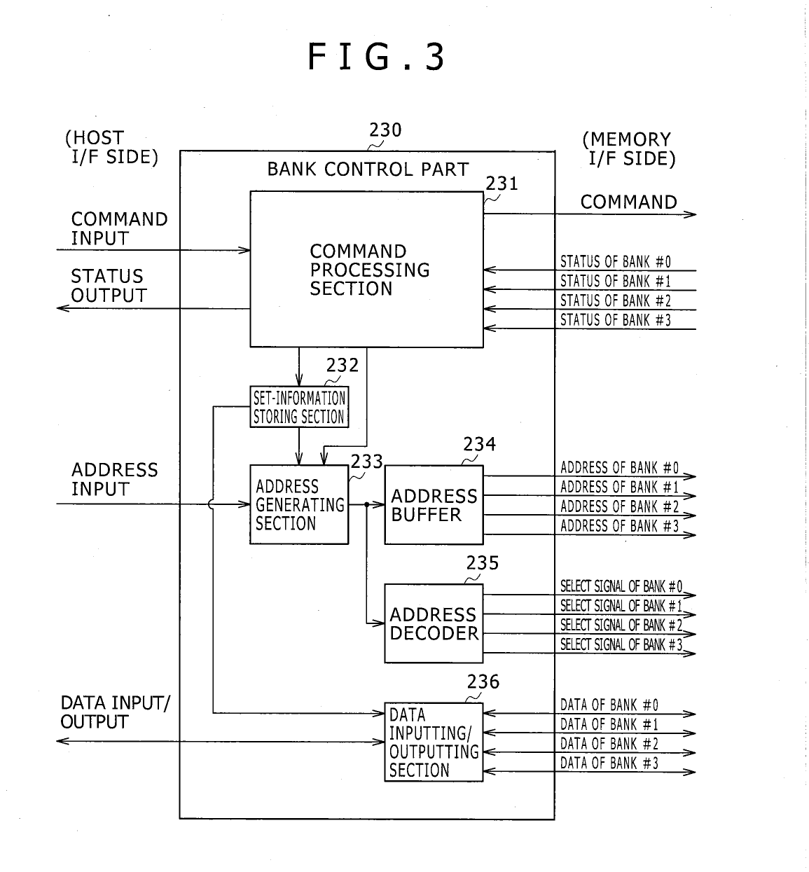

FIG. 3 is a block diagram showing a typical configuration of the bank control part 230 according to an embodiment of the present technology. As shown in the figure, the bank control part 230 includes a command processing section 231, a set-information storing section 232, an address generating section 233, an address buffer 234, an address decoder 235 and a data inputting/outputting section 236.

The command processing section 231 is a configured to process a command received from the host computer 100. The command processing section 231 decodes the received command and carries out operations in accordance with a result of the decoding. In addition, the command processing section 231 receives status generated by the banks 301 to 304 and forwards the status to the host computer 100 in response to the command.

The set-information storing section 232 is a section configured to store set information for every area in the memory space. The set information is assumed to include typically the number of banks to be accessed at the same time and the number of pages in every bank.

The address generating section 233 is a section configured to generate an address in the banks 301 to 304 in accordance with the set information stored in the set-information storing section 232. If a burst transfer according to the embodiment of the present technology is not carried out, received address information is supplied to the address buffer 234 and the address decoder 235 as it is in conformity with the existing accessing method.

The address buffer 234 is a buffer used for storing an address generated by the address generating section 233 as an address in the banks 301 to 304. The address decoder 235 is a configured to decode an address generated by the address generating section 233 and activating a select signal for a particular one of the banks 301 to 304 in accordance with a result of the decoding. The particular bank is a bank serving as an object of the access.

The data inputting/outputting section 236 is a configured to output write data received from the host computer 100 to the banks 301 to 304 and output read data read out from the banks 301 to 304 to the host computer 100.

By virtue of control carried out by the bank control part 230, operations can be carried out on the banks 301 to 304 at the same time.

### Burst-Transfer Commands

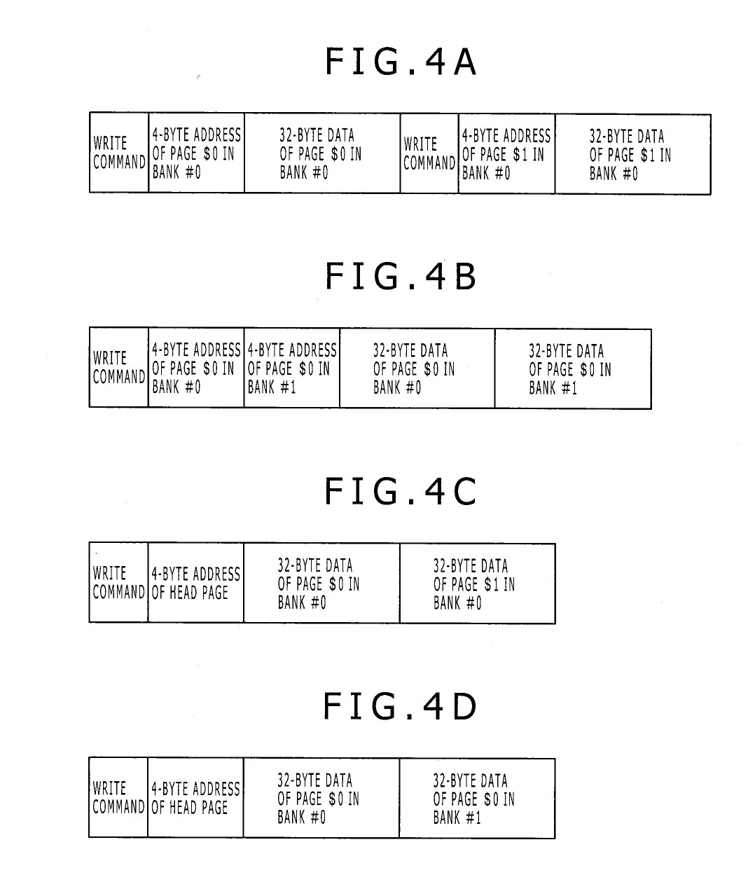

FIGS. 4A to 4D are diagrams showing typical transmission timings of commands executed to make memory accesses by carrying out burst transfers. To be more specific, FIG. 4A shows consecutive page accesses made with the existing timings, which are not speeded up, as accesses to one bank. In this case, a write command and an address are transferred for every page. On the other hand, FIG. 4B shows consecutive multi-bank accesses made with the existing timings, which are not speeded up, as accesses to a plurality of banks. In this case, a write command for the banks and a page address for each of the banks are transferred. As described above, in the existing burst transfer, it is necessary to specify an address for every page or a page address for every bank so that an overhead is incurred.

FIG. 4C shows consecutive page accesses made with typical command transmission timings according to the embodiment of the present technology as accesses to one bank. As shown in the figure, it is necessary to merely specify the address of a head page after a write command. Thus, the transmission of the address needs to be carried out only once. This is because the address generating section 233 generates the address of every page.

On the other hand, FIG. 4D shows consecutive multi-bank accesses made with typical command transmission timings according to the embodiment of the present technology as accesses to a plurality of banks. As shown in the figure, also in this case, it is necessary to merely specify the address of a head page after a write command. Thus, the transmission of the address needs to be carried out only once. This is because the address generating section 233 generates the page address of every bank.

As described above, in accordance with the embodiment of the present technology, the overhead can be reduced by decreasing address information to an address which is required in the first burst transfer. In the case of consecutive page accesses to one bank, the larger the number of pages included in the bank, the more effective the reduction of the overhead. In the case of consecutive multi-bank accesses to a plurality of banks, on the other hand, the larger the number of banks included in the memory system 400, the more effective the reduction of the overhead.

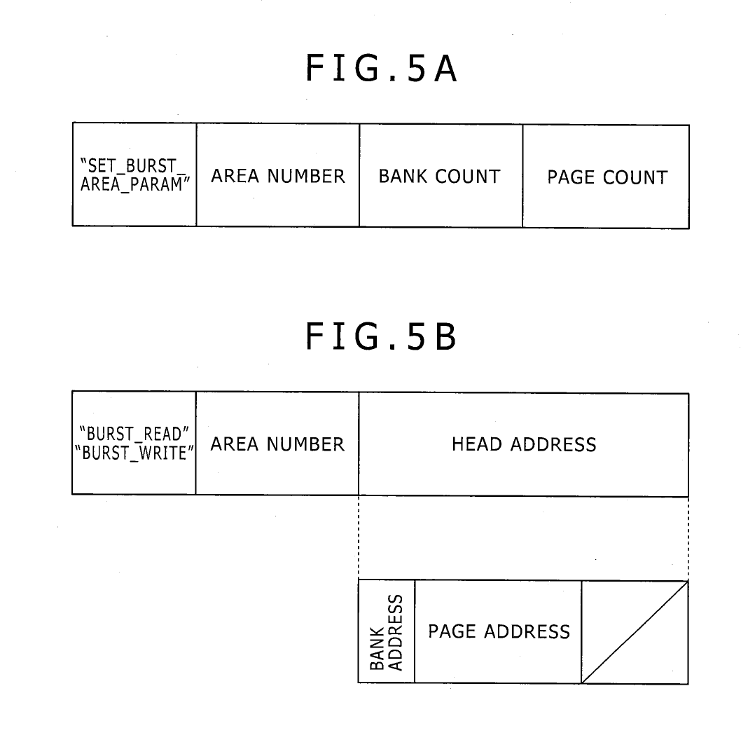

FIGS. 5A and 5B are diagrams showing typical formats of commands for carrying out burst transfers in accordance with an embodiment of the present technology. To be more specific, FIG. 5A shows a burst-transfer setting command for setting set information required in execution of a burst transfer. As shown in the figure, the burst-transfer setting command includes the phrase ‘SET_BURST_AREA_PARAM’ serving as the operation code thereof. In addition, the burst-transfer setting command specifies an area number, the number of banks and the number of pages as operands. Thus, for the area number specified in the burst-transfer setting command, the number of banks to be accessed at the same time and the number of pages included in each of the banks are stored in the set-information storing section 232 as set information.

On the other hand, FIG. 5B shows a burst-transfer executing command for carrying out a burst transfer. As shown in the figure, the burst-transfer executing command includes the phrase ‘BURST_READ’ or ‘BURST_WRITE’ serving as the operation code thereof. The operation code ‘BURST_READ’ indicates that the burst transfer carried out by the burst-transfer executing command is a read burst transfer whereas the operation code ‘BURST_WRITE’ indicates that the burst transfer carried out by the burst-transfer executing command is a write burst transfer. That is to say, ‘BURST_READ’ is the operation code of a burst-transfer executing read command whereas ‘BURST_WRITE’ is the operation code of the burst-transfer executing write command. In addition, the burst-transfer executing command specifies an area number and a start address which serve as operands thereof. Thus, for the area number specified in the burst-transfer executing command, a burst transfer is carried out with the start address taken as the origin address. In this example, more-significant bits of the start address are the address of a bank whereas less-significant bits of the start address are the address of a page in the bank.

In accordance with this burst-transfer executing command, a burst transfer of data is carried out. The size of the data is equal to the product of a page size, a page count and a bank count. The bank count is a value specified in the burst-transfer executing command to represent the number of banks to be accessed at the same time. By the same token, the page count is a value specified in the burst-transfer executing command to represent the number of pages included in each of the banks.

The start address specified in the burst-transfer executing command can be an actual address in a bank or the address of a bank and the offset of an area in the bank. If the start address is an actual address in a bank, the start address does not require an offset address to be explained later by referring to the next figure so that start address has even fewer bits to be transmitted than the existing address information. The offset address is an offset in a page.

### Address Assignment

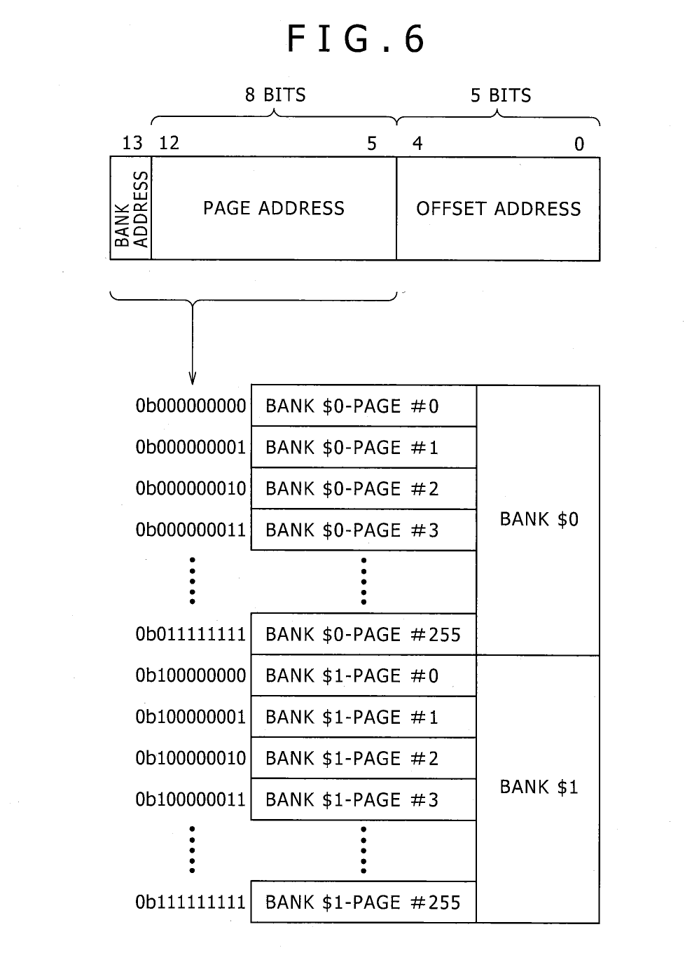

FIG. 6 is a diagram showing typical assignment of addresses to pages in a first embodiment of the present technology. In this first embodiment, the address space of banks has a size of 14 bits starting with the 0th bit on the LSB (Least Significant Bit) side and ending with the thirteenth bit on the MSB (Most Significant Bit) side. The memory system is assumed to have a configuration including two banks which are referred to hereafter as 0th and first banks respectively. The thirteenth bit serving as the MSB is assigned to serve as a bit representing the bank address.

More significant 8 bits starting with the fifth bit and ending with the twelfth bit are assigned to serve as bits representing a page address. On the other hand, less significant 5 bits starting with the 0th bit and ending with the fourth bit are assigned to serve as bits representing an offset address in the page represented by the more significant 8 bits. That is to say, every bank in the 2-bank configuration includes 256 pages each having a size of 32 bytes.

If attention is paid to more significant 9 bits which are the fifth bit to the thirteenth bit in the bit assignment described above, it becomes obvious that every two consecutive pages having successive addresses are included in the same bank. That is to say, 256 consecutive pages are included in the 0th bank whereas the next 256 consecutive pages are included in the first bank. It is to be noted that notation 0b preceding the 9-bit address represented by the more significant 9 bits indicates that the 9-bit address succeeding the notation is a number represented in the binary format.

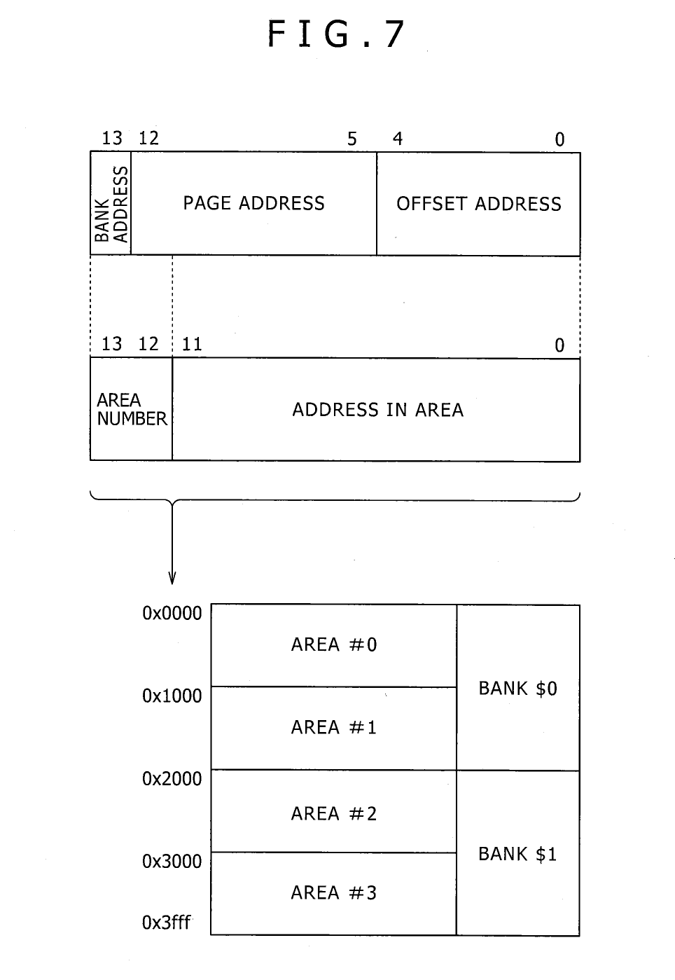

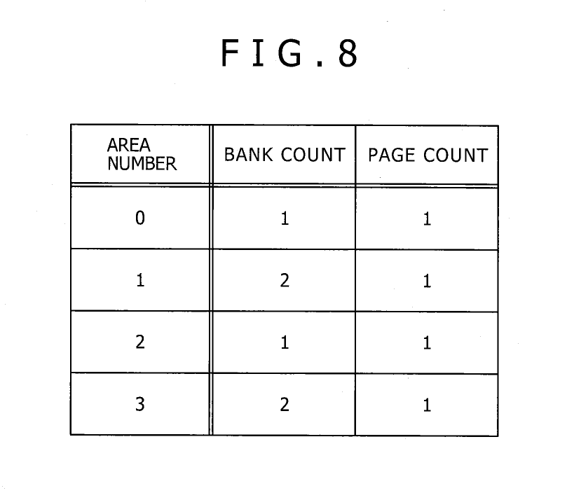

FIG. 7 is a diagram showing typical assignment of area numbers to areas in the first embodiment of the present technology. In this embodiment, the address space of the banks is divided into four adjacent areas each having a size of 4 Kbytes. In the following description, the four areas are referred to as 0th to third areas respectively. For each of the areas, it is possible to set in advance the number of banks to be accessed at the same time and the number of pages included in each of the banks as shown in FIG. 8. An area number is assigned to every area to serve as a number for identifying the area. The twelfth and thirteenth bits are assigned to serve as 2 bits representing the area number. It is to be noted that notation 0x preceding a 4-digit address in FIG. 7 indicates that the 4-digit address succeeding the notation is a number represented in the hexadecimal format. It is also to be noted that, in the first embodiment, the 0th and first areas pertain to the 0th bank whereas the second and third areas pertain to the first bank.

FIG. 8 is a diagram showing typical set information for each area in the first embodiment of the present technology. As shown in the figure, in the first embodiment, for each of the 0th and second areas, the number of banks to be accessed at the same time is set at one whereas the number of pages included in the bank is set at one. For each of the first and third areas, on the other hand, the number of banks to be accessed at the same time is set at two whereas the number of pages included in each of the banks is set at one.

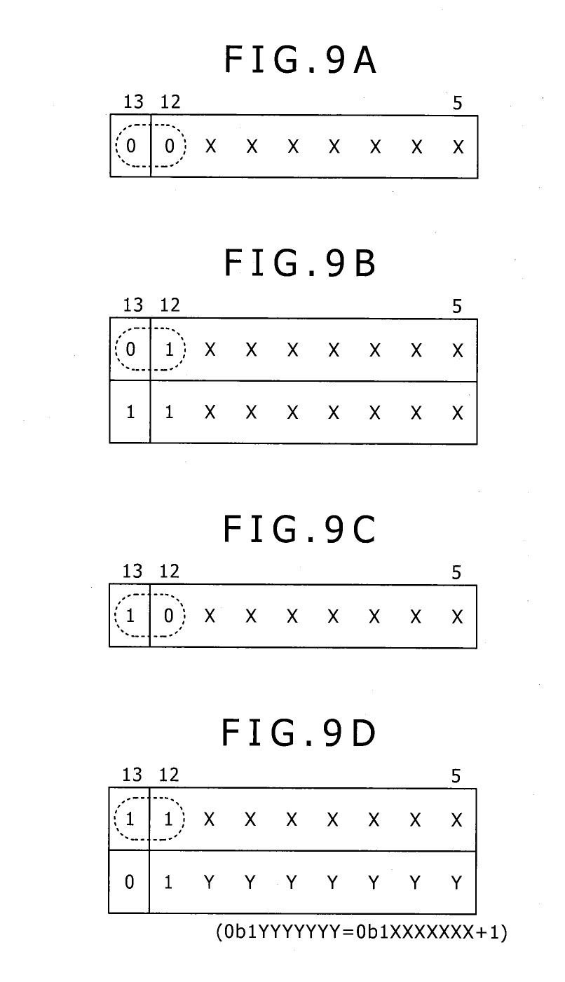

FIGS. 9A to 9D are diagrams showing access addresses for set information in the first embodiment of the present technology. To be more specific, FIG. 9A shows an access address for an area number of 0 representing the 0th area. For the 0th area, the number of banks to be accessed at the same time is set at one whereas the number of pages included in the bank is set also at one. Thus, an access to the one page is made by issuing one command.

FIG. 9B shows an access address for an area number of 1 representing the first area. For the first area, the number of banks to be accessed at the same time is set at two whereas the number of pages included in each of the banks is set at one. Thus, an access to one page in each of the banks is made by issuing one command. That is to say, an access to a total of two pages is made. At that time, since the address of the first area pertains to the 0th bank, the pages having the same address in the 0th and first banks are accessed.

FIG. 9C shows an access address for an area number of two representing the second area. For the second area, the number of banks to be accessed at the same time is set at one whereas the number of pages included in the bank is set also at one in the same way as the 0th area. Thus, an access to the one page is made by issuing one command.

FIG. 9D shows an access address for an area number of three representing the third area. For the third area, the number of banks to be accessed at the same time is set at two whereas the number of pages included in each of the banks is set at one in the same way as the first area. Thus, an access to one page in each of the banks is made by issuing one command. That is to say, an access to a total of two pages is made. At that time, since the address of the third area pertains to the first bank, the pages are accessed by adding 1 to the page address in the first bank in order to obtain an incremented address and making use of the incremented address as the page address of the 0th bank.

### Operations of the Information Processing System

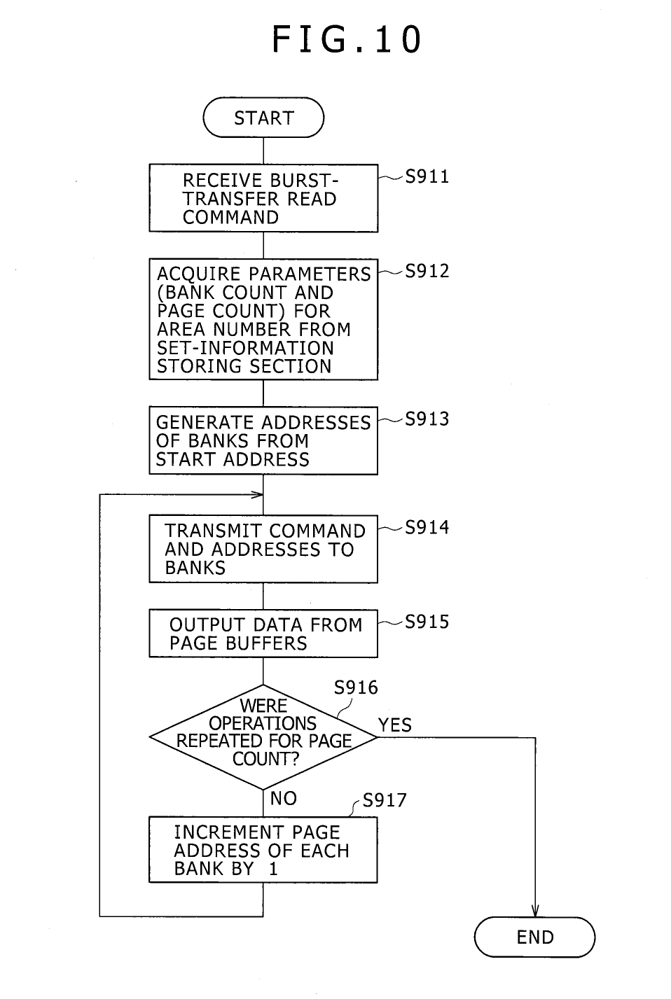

FIG. 10 is a flowchart representing a procedure for processing a burst-transfer read command in accordance with an embodiment of the present technology. As shown in the figure, the flowchart begins with a step S911 at which the command processing section 231 receives a burst-transfer read command. Then, at the next step S912, the set-information storing section 232 outputs parameters for an area number specified in the burst-transfer read command. The parameters are the number of banks to be accessed at the same time and the number of pages included in each of the banks.

Then, at the next step S913, the address generating section 233 generates addresses for the banks 301 to 304 from a start address specified in the burst-transfer read command. Subsequently, at the next step S914, the address buffer 234 transmits the addresses generated by the address generating section 233 to the banks 301 to 304. In addition, at the same step S914, the command processing section 231 transmits the burst-transfer read command to the banks 301 to 304.

Then, at the next step S915, data is read out from the NVRAM cell array 310 included in each of the banks 301 to 304 and the data is output from the page buffer 320 included in each of the banks 301 to 304 to the data inputting/outputting section 236.

Subsequently, the flow of the procedure goes on to the next step S916 in order to determine whether or not the operations of the steps S914 and S915 have been completed for as many pages as those the page count of which is included in set information for the area number specified in the burst-transfer read command. If the operations have not been completed for the pages, the flow of the procedure goes on to a step S917 at which the page address in each of the banks is incremented by 1. Then, the flow of the procedure goes back to the step S914 to repeat the operations. As a matter of fact, the steps S914 to S917 are carried out repeatedly till the operations are completed for the pages.

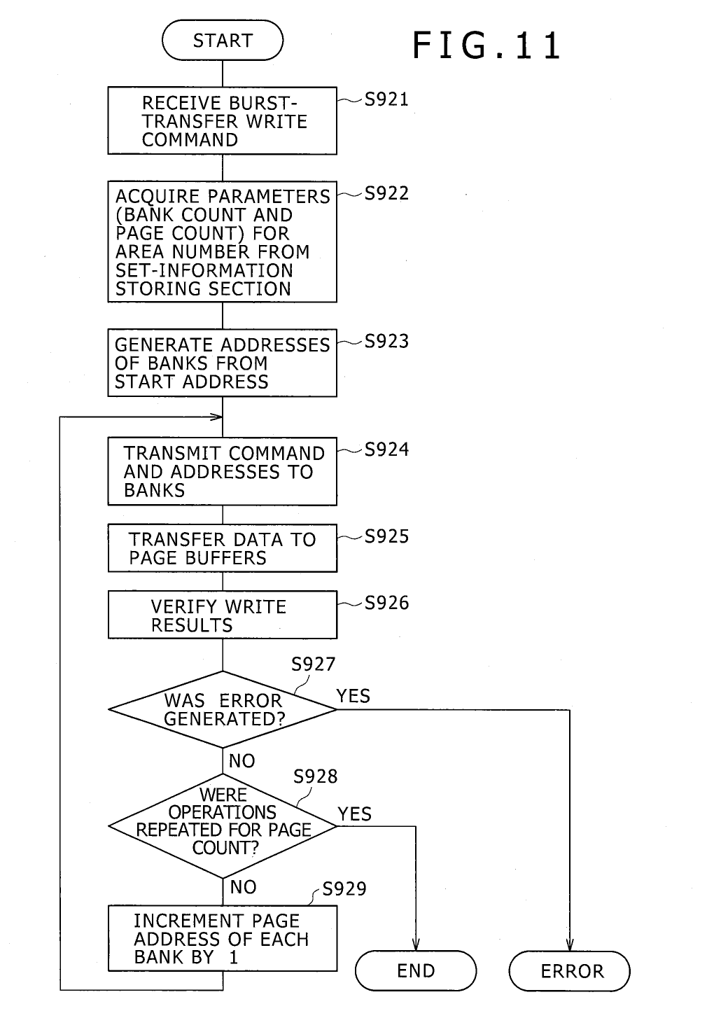

FIG. 11 is a flowchart representing a procedure for processing a burst-transfer write command in accordance with an embodiment of the present technology. As shown in the figure, the flowchart begins with a step S921 at which the command processing section 231 receives a burst-transfer write command. Then, at the next step S922, the set-information storing section 232 outputs parameters for an area number specified in the burst-transfer write command. The parameters are the number of banks to be accessed at the same time and the number of pages included in each of the banks.

Then, at the next step S923, the address generating section 233 generates addresses for the banks 301 to 304 from a start address specified in the burst-transfer write command. Subsequently, at the next step S924, the address buffer 234 transmits the addresses generated by the address generating section 233 to the banks 301 to 304. In addition, at the same step S924, the command processing section 231 transmits the burst-transfer write command to the banks 301 to 304. Subsequently, at the next step S925, write data is transferred to the page buffers 320 of the banks 301 to 304.

Then, when the write data is written into the NVRAM cell array 310 included in each of the banks 301 to 304, the status of the write operation is output from the page buffer 320 included in each of the banks 301 to 304 to the command processing section 231. Subsequently, at the next step S926, the command processing section 231 verifies results of the write operation on the basis of the status. Then, the flow of the procedure goes on to the next step S927 in order to determine whether or not an error has been detected in the verification. If an error has been detected, the execution of the procedure is ended due to the detected error.

If no error has been detected, on the other hand, the flow of the procedure goes on to the next step S928 in order to determine whether or not the operations of the steps S924 to S927 have been completed for as many pages as those the page count of which is included in set information for the area number specified in the burst-transfer write command. If the operations have not been completed for the pages, the flow of the procedure goes on to a step S929 at which the page address in each of the banks is incremented by 1. Then, the flow of the procedure goes back to the step S924 to repeat the operations. As a matter of fact, the steps S924 to S929 are carried out repeatedly till the operations are completed for the pages.

As described above, according to the first embodiment of the present technology, the address of every page subjected to a burst transfer is generated in accordance with set information set in advance for every area. Thus, it is possible to shorten the specification of an address in the burst-transfer read or write command. Particularly, in the case of the first embodiment, a portion consisting of significant bits is assigned to serve as a portion used to specify a bank address. Thus, consecutive addresses can be assigned to pages in each bank so that, for the banks, burst transfers can be carried out independently of each other.

### 2: Second Embodiment

In the case of the first embodiment described above, consecutive addresses are assigned to pages in each bank. In the case of a second embodiment, on the other hand, consecutive addresses are spread across a border between adjacent banks. It is to be noted that, in the second embodiment, the configuration of the information processing system and operations carried out by the system as well as the assumed commands are identical with those for the first embodiment. Thus, the configuration, the operations and the commands are not explained again in the following description.

### Address Assignment

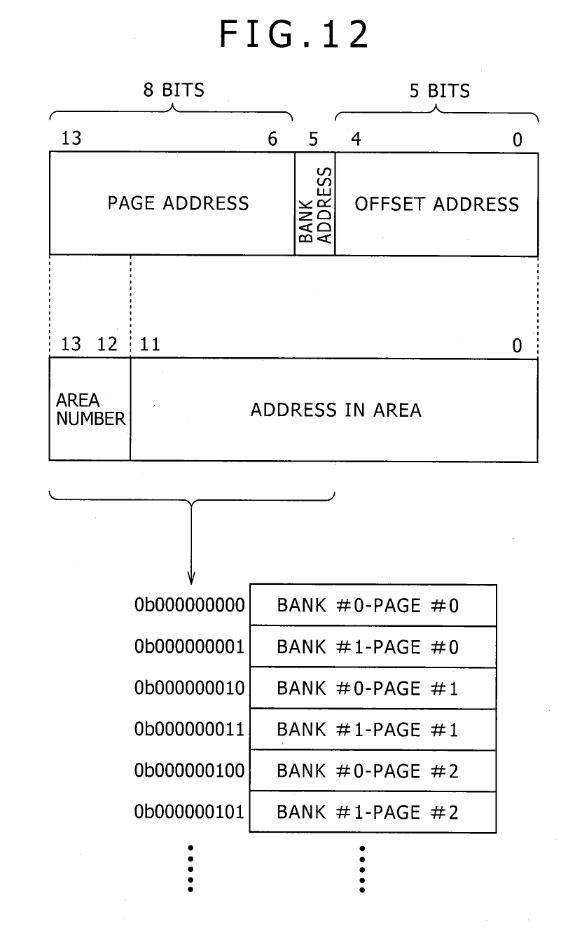

FIG. 12 is a diagram showing typical assignment of addresses to pages in the second embodiment of the present technology. Much like the first embodiment, in this second embodiment, the address space of banks has a size of 14 bits starting with the 0th bit on the LSB (Least Significant Bit) side and ending with the thirteenth bit on the MSB (Most Significant Bit) side. The memory system is assumed to have a configuration including two banks.

The first and second embodiments are different from each other in that, in the case of the second embodiment, more significant 8 bits starting with the sixth bit and ending with the thirteenth bit are assigned to serve as bits representing a page address. Much like the first embodiment, less significant 5 bits starting with the 0th bit and ending with the fourth bit are assigned to serve as bits representing an offset address in the page represented by the more significant 8 bits. In addition, every bank in the 2-bank configuration includes 256 pages each having a size of 32 bytes.

The first and second embodiments are also different from each other in that these embodiments have different bit positions for the bank address. To put it concretely, in the case of the second embodiment, the fifth bit is assigned to serve as a bit representing the bank address. If attention is paid to more significant 9 bits which are the fifth bit to the thirteenth bit in the bit assignment described above, it becomes obvious that the same page having successive addresses is spread across a border between different banks. That is to say, the consecutive pages having successive addresses are spread alternately over 0th and first banks.

It is to be noted that, much like the first embodiment, also in the case of the second embodiment, the address space of the banks is divided into four adjacent areas each having a size of 4 Kbytes. The twelfth and thirteenth bits are assigned to serve as 2 bits representing the area number. In the case of the second embodiment, however, data of each area is spread across a border between different banks.

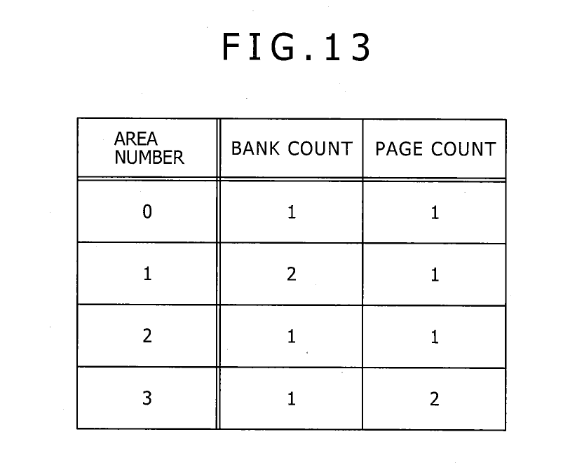

FIG. 13 is a diagram showing typical set information for each area in the second embodiment of the present technology. As shown in the figure, in the case of the second embodiment, for each of the 0th and second areas, the number of banks to be accessed at the same time is set at one whereas the number of pages included in the bank is set at one. For the first area, the number of banks to be accessed at the same time is set at two whereas the number of pages included in each of the banks is set at one. For the third area, the number of banks to be accessed at the same time is set at one whereas the number of pages included in each of the banks is set at two.

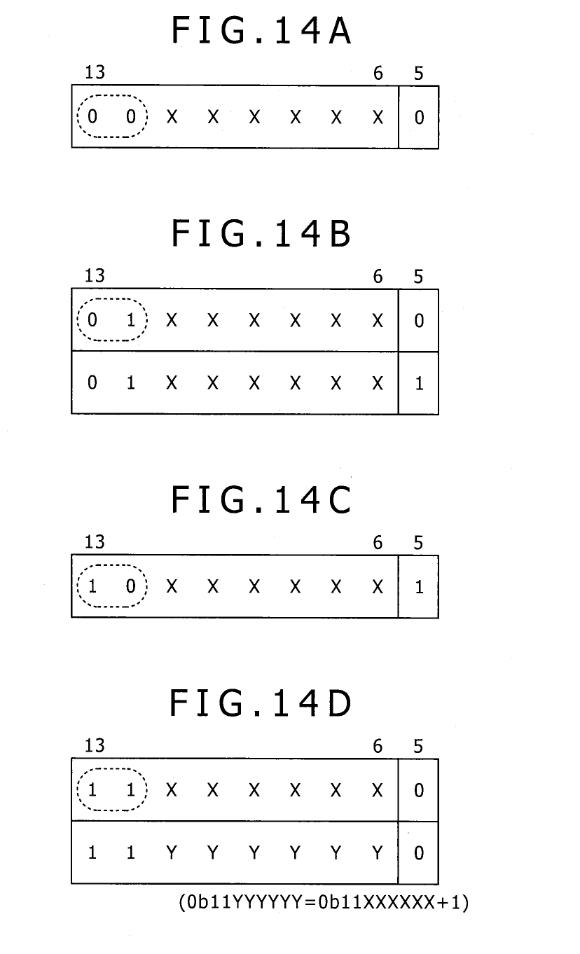

FIGS. 14A to 14D are diagrams showing access addresses for set information in the second embodiment of the present technology. To be more specific, FIG. 14A shows an access address for an area number of 0 representing the 0th area. For the 0th area, the number of banks to be accessed at the same time is set at one whereas the number of pages included in the bank is set also at one. Thus, an access to the one page is made by issuing one command.

FIG. 14B shows an access address for an area number of 1 representing the first area. For the first area, the number of banks to be accessed at the same time is set at two whereas the number of pages included in each of the banks is set at one. Thus, an access to one page in each of the banks is made by issuing one command. That is to say, an access to a total of two pages is made. At that time, since the address of the first area pertains to the 0th bank, the pages having the same address in the 0th and first banks are accessed.

FIG. 14C shows an access address for an area number of two representing the second area. For the second area, the number of banks to be accessed at the same time is set at one whereas the number of pages included in the bank is set also at one in the same way as the 0th area. Thus, an access to the one page is made by issuing one command.

FIG. 14D shows an access address for an area number of three representing the third area. For the third area, the number of banks to be accessed at the same time is set at one whereas the number of pages included in each of the banks is set at two. Thus, an access to two pages in the same bank is made by issuing one command. In this case, the two pages having consecutive page addresses in the 0th bank are accessed.

As described above, in accordance with the second embodiment of the present technology, a portion consisting of significant bits is assigned to serve as a portion used to specify a page address. It is thus possible to assign consecutive addresses to different banks and have the banks collaborate with each other in order to carry out a burst transfer.

### 3: Typical Application

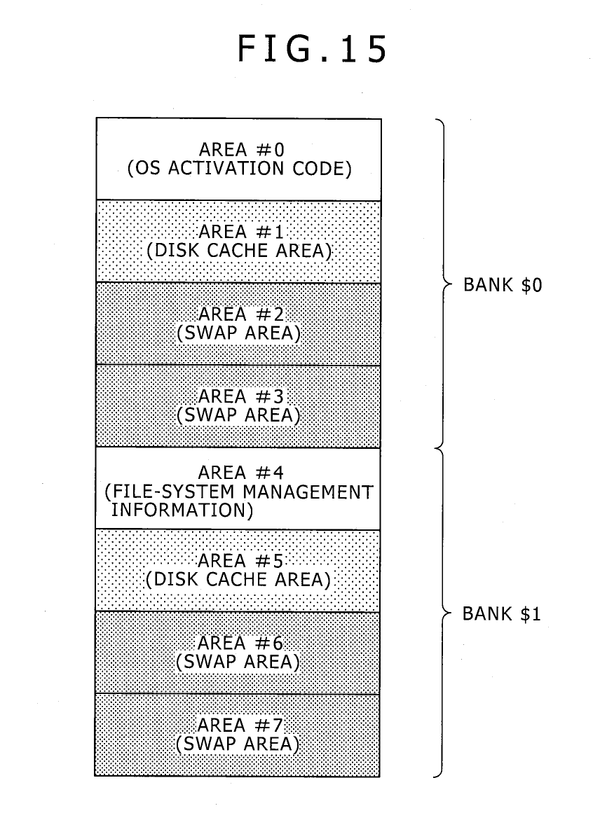

FIG. 15 is a diagram showing typical usages of areas for a case in which an embodiment of the present technology is applied to an information processing system. As shown in the figure, in this typical application, the address space is divided into eight areas referred to hereafter as 0th to seventh areas respectively, and a configuration including two banks is assumed. The 0th to third areas are assigned to the 0th bank whereas the fourth to seventh areas are assigned to the first bank.

The 0th area is an area used for storing code for activating the OS (Operating System). The access size is typically 128 bytes. Since accesses to this area are mainly read accesses, it is not necessary to adopt a multi-bank access technique. In this example, only the 0th bank is allocated to the code for activating the OS.

The first and fifth areas are a cache area of a disk drive such as an HDD (Hard Disk Drive). The access size is typically 512 bytes. Since write operations need to be carried out at a high speed, in this example, the first and fifth areas are placed in the 0th and first banks respectively.

The second and third areas or the sixth and seventh areas are a swap area of a virtual memory system. The access size is typically 4,096 bytes. Since the access size is large, in this example, both the 0th and first banks are used so as to conform to the multi-bank access technique and the multi-page access technique.

The fourth area is an area used for storing management information of the file system. The access size is typically 32 bytes. Since the access size is small, it is not necessary to adopt a multi-bank access technique. That is to say, in this example, only the first bank is used.

As is obvious from the above description of the typical example, the number of banks to be accessed at the same time and the number of pages included in each of the banks can be set in advance for every area in accordance with the property of data serving as an object of the access.

It is to be noted that each embodiment described above is merely a typical implementation of the present technology. Each item of the embodiment is associated with a specific item of an invention described in a claim. By the same token, each specific item of an invention described in a claim is associated with an item included in the embodiment and referred to as the same name as the specific item of the invention. However, the scope of the present technology is by no means limited to the embodiments. That is to say, in order to implement the present technology, the embodiments can be changed in a variety of ways within a range not deviating from essentials of the present technology.

In addition, each processing procedure explained in the descriptions of the embodiments can be interpreted as a method for carrying out operations sequentially. As an alternative, the sequence of operations can be carried out by a computer for executing a program stored in a recording medium. Typical examples of the recording medium are a CD (Compact Disc), an MD (Mini Disc), a DVD (Digital Versatile Disk), a memory card and a Blu-ray Disc (a trademark), to mention a few.

It is to be noted that the present technology can also be realized as the following implementations.

1. A storage control apparatus including:

a command processing section configured to receive a command requesting accesses to a plurality of access units by specifying an address in a memory space including a plurality of banks; and

an address generating section configured to generate an address of an access unit serving as an object of the accesses in a bank selected from the banks as a bank determined in advance for the specified address.

2. The storage control apparatus according to implementation 1 further having a set-information storing section configured to store set information which includes the number of banks to be accessed at the same time in accordance with an address in the memory space and the number of access units in each of the banks, wherein the address generating section generates an address of an access unit serving as an object of the accesses in accordance with the set information.

3. The storage control apparatus according to implementation 2 wherein the address generating section generates an address for each of different banks in accordance with a bank count included in the set information to represent the number of banks to be accessed at the same time.

4. The storage control apparatus according to implementation 2 wherein the address generating section generates successive addresses of consecutive access units in every bank in accordance with an access-unit count included in the set information to represent the number of access units.

5. The storage control apparatus according to any one of implementations 1 to 4 wherein:

the address specified in the command is a start address of the accesses made in accordance with the command; and

the address generating section generates an address of an access unit serving as an object of the accesses by making use of the start address as an origin.

6. The storage apparatus including:

a memory array including a plurality of banks;

a command processing section configured to receive a command requesting accesses to a plurality of access units by specifying an address in a memory space of the memory array; and

an address generating section configured to generate an address of an access unit serving as an object of the accesses in a bank selected from the banks as a bank determined in advance for the specified address.

7. The storage apparatus according to

implementation 6 wherein the memory array employ memory cells which are each a variable-resistance device.

8. An information processing system including:

a memory array including a plurality of banks;

a command processing section configured to receive a command requesting accesses to a plurality of access units by specifying an address in a memory space of the memory array;

an address generating section configured to generate an address of an access unit serving as an object of the accesses in a bank selected from the banks as a bank determined in advance for the specified address; and

a host computer issuing a read command or a write command to the memory array.

9. A storage control method including:

receiving a command requesting accesses to a plurality of access units by specifying an address in a memory space including a plurality of banks; and

generating an address of an access unit serving as an object of the accesses in a bank selected from the banks as a bank determined in advance for the specified address.

The present disclosure contains subject matter related to that disclosed in Japanese Priority Patent Application JP 2012-070830 filed in the Japan Patent Office on Mar. 27, 2012, the entire content of which is hereby incorporated by reference.

It should be understood by those skilled in the art that various modifications, combinations, sub-combinations and alterations may occur depending on design requirements and other factors in so far as they are within the scope of the appended claims or the equivalents thereof.

What is claimed is:

1. A storage control apparatus comprising:
a command processing section configured to receive a command requesting accesses to a plurality of access units by specifying an address in a memory space including a plurality of banks; and
an address generating section configured to generate an address of an access unit serving as an object of said accesses in a bank selected from said banks as a bank determined in advance for said specified address.

2. The storage control apparatus according to claim 1 further having
a set-information storing section configured to store set information which comprises the number of banks to be accessed at the same time in accordance with an address in said memory space and the number of access units in each of said banks, wherein
said address generating section generates an address of an access unit serving as an object of said accesses in accordance with said set information.

3. The storage control apparatus according to claim 2 wherein
said address generating section generates an address for each of different banks in accordance with a bank count included in said set information to represent the number of banks to be accessed at the same time.

4. The storage control apparatus according to claim 2 wherein
said address generating section generates successive addresses of consecutive access units in every bank in accordance with an access-unit count included in said set information to represent the number of access units.

5. The storage control apparatus according to claim 1 wherein:
said address specified in said command is a start address of said accesses made in accordance with said command; and
said address generating section generates an address of an access unit serving as an object of said accesses by making use of said start address as an origin.

6. A storage apparatus comprising:
a memory array including a plurality of banks;
a command processing section configured to receive a command requesting accesses to a plurality of access units by specifying an address in a memory space of said memory array; and
an address generating section configured to generate an address of an access unit serving as an object of said accesses in a bank selected from said banks as a bank determined in advance for said specified address.

7. The storage apparatus according to claim 6 wherein
said memory array employ memory cells which are each a variable-resistance device.

8. An information processing system comprising:
a memory array including a plurality of banks;
a command processing section configured to receive a command requesting accesses to a plurality of access units by specifying an address in a memory space of said memory array;
an address generating section configured to generate an address of an access unit serving as an object of said accesses in a bank selected from said banks as a bank determined in advance for said specified address; and
a host computer issuing a read command or a write command to said memory array.

9. A storage control method comprising:
receiving a command requesting accesses to a plurality of access units by specifying an address in a memory space including a plurality of banks; and
generating an address of an access unit serving as an object of said accesses in a bank selected from said banks as a bank determined in advance for said specified address.
